(19) United States
(12) Patent Application Publication
(10) Pub. No.: US 2019/0134682 A1
(43) Pub. Date: May 9, 2019

(54) METHODS COMPRISING TO CLEAN AND/OR LUBRICATE FLUID ENCOMPASSING SYSTEMS

(71) Applicants: Michael Overmyer, Danville, KY (US); Thad J. OVERMYER, DANVILLE, KY (US)

(72) Inventors: Michael Overmyer, Danville, KY (US); Thad J. OVERMYER, DANVILLE, KY (US)

(21) Appl. No.: 15/802,821

(22) Filed: Nov. 3, 2017

(51) Int. Cl. B08B 9/032

(52) U.S. Cl. CPC B08B 9/032; B08B 2209/032

(57) ABSTRACT

Methods comprised to clean and/or lubricate fluid encompassing systems and systems' components comprising of a sequence of procedural steps. These systems' and components are susceptible to buildup of contamination and remnants from a chemical agent in this system, which can cause equipment failure if not properly maintained by using an effective method comprised to clean and/or lubricate this system.

This method ensures a chemical agent's physical and chemical and properties are not altered when applied to this system. This method directs a flow of a chemical agent onto the surfaces of this system's components.

After this system is cleaned and/or lubricated using this invention's method, this method's final step removes a chemical agent and/or contamination from this system to prevent consumer(s) from ingesting this chemical agent and/or contamination. This method also ensures no residue and no remnants from a chemical agent and/or contamination remains in this system, which helps prevent equipment failure, corrosion, and buildup within said system.

This method helps maintain and/or improve the functionality of this system, which helps prolong the life span of this system and said system's components.

### BACKGROUND OF THE INVENTION

The present invention provides methods comprising to clean and/or lubricate fluid encompassing systems. A fluid encompassing system that dispenses a fluid or fluids for in vitro and/or in vivo procedures and/or for consumption must be cleaned and/or lubricated.

This fluid encompassing system may contain components comprising of fluid conduit(s), and/or fluid reservoir(s), and/or valve(s), and/or device(s).

A fluid encompassing system and this system's encompassing fluid are both susceptible to contamination. During the use of this system, a layer of contaminates forms within said system's components. When this fluid encompassing system is not cleaned and/or lubricated properly, contaminates remain in this system and create a buildup of contamination. This contamination in this system will contaminate this system's encompassing fluid and said system.

The surfaces of this system's components: fluid conduit(s), fluid reservoir(s), and valve(s) are the location of the contamination. This system's encompassing fluid becomes contaminated when contacting the contaminated surfaces of this system's components. For example, this system's fluid becomes contaminated when transported through this system's contaminated fluid conduit(s); and/or this system's fluid becomes contaminated when flowing through this system's contaminated valves; and/or this system's fluid becomes contaminated when being contained in this system's contaminated fluid reservoir. Contamination affects the fluid quality of said system's encompassing fluid. Cleaning this system routinely with this invention's method using a cleaning chemical agent will clean the contamination in this system, which helps maintain and control the chemical and physical properties for this system's encompassing fluid.

Contamination forms on rubber, polyurethane, various types of metal, glass, plastic and silicone surfaces which are materials often used for said system's components: fluid conduit(s) and fluid reservoir(s).

Contamination growth in a fluid encompassing system effects many industries including healthcare, food, hospitality, and water treatment. The build-up of contamination in a fluid encompassing system can effect immunosuppressed people, system functions, aerosolization from said system's devices, system's encompassing's fluid flow, and tastes and odors in system's encompassing fluid.

Common examples of fluids that encompass a fluid encompassing system: water, milk, medical solutions, fluid admixtures, blood, cold beverages, hot beverages, frozen beverages, sodas, ice cream, yogurt, tea, fruit juice, beer, wine, coffee, consumables, alcohol spirits, liquor, liqueur and other fluids that encompass a fluid encompassing system.

Some examples of a fluid encompassing system are a soda fountain machine, draft beer keg encompassing system, surgical laser system, beverage brewing machine, and a dental unit water system.

Various types of chemical agents are recommended to clean and/or lubricate said fluid encompassing system. When a chemical agent is not completely removed from this system, this system's end product, the encompassing fluid's taste, chemical and physical properties are affected from the remnants of the chemical agent and/or contamination from said system.

Bleach based chemical agents are often used to clean a fluid encompassing system. If the bleach remnants from the bleach-based chemical agent remain in said system, these bleach remnants will alter the taste of this system's encompassing end product. For example, if this system's encompassing fluid was beer, then the beer's taste will be altered from the remnants of the chemical agent in said system.

A method used by only flushing the contaminated fluid conduits with water, does not remove contaminants of the inner walls of this fluid conduit due to laminar flow.

Common methods used to clean and/or lubricate a fluid encompassing system are to flush a high-temperature-short-time treatment such as pasteurization through this system or flush a pressurized chemical agent through said system. The length of time the chemical agent remains in this system depends on the manufacturer of this chemical agent's recommendation. After a designated period of time, the chemical agent is flushed with pressurized water or this system's end product. The system is now considered clean and/or lubricated.

A dental unit water system will be used as a specific example to explain the importance in cleaning a fluid encompassing system and how the contributing factors for contamination grows in a fluid encompassing system. This dental unit water system will also clarify the differences between cleaning chemical agents for fluid encompassing systems compared to products and methods that treat the system's encompassing fluid. The dental unit water system will also show how a system's contaminates effects this system's fluid quality, regardless if a system's fluid was treated. Furthermore, for maintenance purposes, this dental unit water system example will demonstrate how fluid encompassing systems and components use a lubricant chemical agent to lubricate the system's surfaces and system's components such as valves and devices to maintain and/or enhance the system's functionality.

In healthcare, water is a common fluid used with a fluid encompassing system when performing medical/dental procedures upon patients. Water quality is important, especially when water is the dispensing fluid in a fluid encompassing system. Water quality is measured in CFU, colony-forming units/mL. This unit of measure is for the number of bacteria colonies found in one milliliter. Heterotrophic bacteria plate count is a procedure for estimating the number of live heterotopic bacteria in the water. Colonies may form in pairs, clusters or single cells, which can be termed as “colony-forming units”.

Dental unit water is the dental unit water system's encompassing fluid that is used for dental operative procedures. All dental unit water including treated dental unit water are susceptible to contamination. The CDC (Centers for Disease Control), recommends that dental unit water used in non-surgical procedures measures less than or equal to 500 colony forming units of heterotrophic bacteria per milliliter (≤500 CFU/mL) of water, which is also the standard set for drinking water by the EPA (Environmental Protection Agency), APHA (American Public Health Association), and the AWWA (American Water Works Association).

A dental unit water system's components comprises of fluid conduit(s) are dental unit waterlines; fluid reservoir(s) are dental water bottle(s) and/or dental water heater(s); valves; and the device(s) are dental handpieces and three-way syringe(s).

The dental water bottle is a fluid reservoir for the dental unit water. The dental water bottle is attached to the dental unit manifold. This manifold has a dental unit waterline called a dental water bottle pick-up tube that transports the dental unit water from the dental water bottle to the handpieces and three-way syringes.

Dental unit waterlines (DUWLs) are narrow-bore tubing used to deliver dental unit water for high-speed dental handpieces, air-water syringes, and dental unit water quick disconnects.

Contamination adheres to the inner tubal walls of dental unit waterlines. The ADA (American Dental Association) confirms research showing that a dental unit water system had high microbial counts as high as 200,000 CFU/mL within 5 days of installing new dental unit waterlines.

The same dental office can have multiple dental unit water systems in each dental operatory, but each of these systems will have different microbial CFU counts due to the many various factors that contribute to contaminate growth in a dental unit water system.

Contamination inside the dental unit water system affects the dental unit water quality. When the dental unit water becomes penetrated from the contaminates of the dental unit water system, this dental unit water's taste, composition and water quality are altered.

A combination of any of the following encourages rapid growth of contamination in the dental unit water system: stagnant dental unit water, warm dental unit water temperatures, dental water heaters, small dental unit waterlines tubing diameter, dead ends on dental unit, backflow of oral fluids from patient, handpiece connectors disconnected, poor hygienic ethics by dental office staff, contaminated dental water bottle pick-tube, contaminated dental water bottles, and dental unit water source.

Stagnant dental unit water remaining in this dental unit water system's components creates contamination. The small lumen of the dental unit's waterlines and the small amount of dental unit water used for dental procedures creates stagnant water, which increases the contamination of the dental unit water. This contamination forms on the inner walls of the dental unit waterlines, passages of valves and other said components with dental unit water flow.

A dead end is a blocked waterline within the dental unit. A dead end on a dental unit is a point at which the dental unit water does not continuously flow and is stopped by a valve. A dead end is a harbor for contamination if not properly cleaned.

Dead end examples are the water quick disconnect, slow speed handpiece waterline and/or a water pressure gauge connected to a waterline.

Backflow of oral fluids from a patient is caused when a dental high-speed handpiece's turbine creates a vacuum that sucks the patient's oral fluids back into this handpiece, which leads to contaminating the dental unit waterlines.

Contamination in the dental unit water system can occur when a dental office has poor hygienic ethics by not following protocols, not cleaning dental unit water system, not using an effective cleaning method, not washing hands properly, and not wearing gloves. Even if a staff member is wearing gloves, the gloves are not sterile. A staff member can cause contamination within the dental unit water system when touching dental system's components.

When handpiece connectors are disconnected, these connectors are exposed and susceptible to contamination from aerosolization of bacteria contaminates in dental operatory and being touched by staff members.

There are many examples how the dental water bottle pick-up tube becomes contaminated. When re-attaching the dental water bottle to the dental unit, the pick-up tube's external surfaces are contaminated when a staff member touches this pick-up tube when inserting said tube inside the dental water bottle. The staff members' gloves are not sterile. This pick-up tube's contaminated external surface leads to further contamination in the dental unit water of the dental water bottle. Furthermore, this contaminated dental unit water contained by a dental water bottle will then contaminate this bottle.

When the dental water bottle is not attached to the dental unit, the pick-up tube becomes exposed to aerosols and atmospheric contaminants. This is an example of pick-up tube contamination.

The high-density polyethylene (HDPE) plastic dental water bottles are susceptible to contamination. Dental unit water remaining in a dental water bottle becomes stagnant, a contributing factor to growth of contaminates. Contamination adheres to the inner walls of the dental water bottle. Another example of a contaminated dental water bottle is when the inside of the dental water bottle are not being cleaned on a routine basis before filling it with dental unit water source.

All dental unit water sources are susceptible to contamination. Dental unit water without an antimicrobial agent will become more contaminated than water treated with an antimicrobial agent. The common dental unit water sources are municipal water, distilled water, spring bottled water, and well water.

The municipal drinking water source is treated with chlorine, an antimicrobial agent, to ensure this water is a safe drinking water for the community. However, not all cities have quality drinking water. Depending on the geographic area, some cities may have hard municipal water.

When dental offices have hard municipal water for their dental unit water, the hard water mineral deposits: calcium, magnesium, and iron contribute to contamination growth in the dental unit, clog dental unit waterlines, and cause a low water flow from the high-speed handpieces and air-water syringes. These mineral deposits from the hard municipal water can also impact the life span of some dental chemical agents; however, the present invention's methods are not affected by a dental office's water source.

Distilled water source and spring bottled water source have a 24-hour shelf life once opened, since they do not contain an antimicrobial agent.

Dental offices in the rural areas that use well water as their dental unit water source do not contain any antimicrobial agents.

All dental unit water sources including treated dental unit water are susceptible to contamination. Examples of treated dental unit water: municipal water, filtered water, UV treated water, purified water, spring bottled water, and distilled water.

The dental water treatment products do not clean and/or lubricate dental unit waterlines. Presently, a common misconception in dentistry is the difference between water treatment products and dental waterline cleaning agents.

Dental water treatment products only treat dental unit water. Water treatment products and treated dental unit water do not remove contamination from the dental unit waterlines. For example, treated dental unit water is supplied to contaminated dental unit waterlines. This treated dental unit water becomes penetrated and contaminated when contacting the contaminated dental waterlines, which increases the microbial CFU count in this dental unit water. This results with contaminated dental unit water being dispensed for dental procedures.

Dental waterline cleaning agents used routinely to clean the contamination in the dental unit water system helps maintain and control the dental unit water quality. Dental waterline cleaning agents do not treat dental unit water.

Contamination occurs in the dental unit even when treated dental unit water is present. Water treatment products refer in their product instructions to use a dental waterline cleaning agent to ‘shock’ the dental waterlines. The term, “shocking” is a marketing term created and replaced the word, “clean”. Shocking means to clean the dental unit waterlines.

The water treatment products refer to use a dental waterline cleaning agent, because water treatment products and treated dental unit water do not clean the contamination from the dental unit waterlines. Water treatment products only treat dental unit water and supply this water to the contaminated dental unit waterlines, which causes this dental unit water to become contaminated.

Most common water treatment products exist in the form of tablets, water filters, cartridges, straws, and water purification systems.

Filters have no effect on contamination in dental unit waterlines. Dental unit water passes through the porous material in order to separate particulates or biological matter. Matter separated depends on the physical characteristic of the filter material. To remove most bacteria, filters must have a pore of 0.2 microns or less. A filter is found in various locations of the dental unit water system depending on the type of filter. Filters collect planktonic bacteria and the filter can become blocked from not being cleaned or replaced with a new filter. The blockage filter is an example of a dead end, which is a blocked water passage within the dental unit water system, which increases the microbial CFU count in the dental unit water. The life span of this filter depends on the quality of dental unit water. The dental unit water system with a filter usually remains connected to municipal water.

Another form of a water treatment product is a resin filled cartridge impregnated with chemicals that function by the dental unit water or air passing through the cartridge on the chemically impregnated resin. The dental unit water and/or air picks up the chemical agent. This cartridge method requires using a dental waterline cleaning agent periodically to remove contamination in the dental unit water system to ensure effectiveness of the cartridge.

Ultra violet lights improves the quality of incoming dental unit water by killing bacteria that pass in front of the UV light in the waterline. The UV light does not have an effect on contamination in the dental unit water system.

Water distillers may improve dental unit water quality. This water treatment method is used with any dental unit equipped with dental water bottles. If dental unit waterlines and dental water bottles are not properly cleaned and the distiller malfunctions, this water treatment method will produce bacterially contaminated water.

Chemicals for continuous water treatment mixed with dental unit water inactivate suspended bacteria. This water treatment method is usually used continuously during patient treatment, but has little to no effect on contamination in the dental unit water system.

The present method may used with a dental waterline cleaning agent that cleans and controls the contamination in the dental water system, which helps maintain the dental unit water quality. This method that uses a dental waterline cleaning agent is compatible with all dental units. This dental waterline cleaning agent and contamination are removed from this system with this method's final step resulting with purging this system and/or flushing/rinsing said system that does not impact dental operative procedures and does not result in patient exposure to said dental waterline cleaning agent and contamination when this invention's method is performed correctly.

In conclusion, dental unit water treatment products have no effect on the contamination growth in the dental unit water system. All dental unit water including treated dental unit water are susceptible to growth of contaminates regardless of the dental unit water source used and if a water treatment product treated the dental unit water.

The dental unit water system must be cleaned routinely with a chemical agent that is used with a method such as using this invention's method in order to clean the contamination from the dental unit system, which helps provide consistent dental unit water to patients that meets the CDC's recommend dental unit water quality standards.

Earlier in my U.S. patents:
1. U.S. Pat. No. 4,668,190 I disclosed a liquid admixing apparatus for dental water-injection systems. Liquid admixing means for a dental oral water-injection system are provided for introducing an additive liquid from a reservoir through an additive tube into a water conduit in the water-injection system wherein a valve in the additive tube can be opened and closed remotely by manually operable means.
2. U.S. Pat. No. 4,695,255 I disclosed a method of cutting and lubricating human hard tissue during power tool cutting wherein the tissue subjected to cutting has directed against it a liquid admixture of water as a cooling agent, alcohol as an anti-infection agent and glycerin as a lubricant.
3. U.S. Pat. No. 5,318,443 I disclosed a method of flushing, disinfecting a dental turbine handpiece by forcing a pressurized solution of a disinfectant and lubricant simultaneously through an air drive line to the handpiece when is not in operation to flush dental debris through an exhaust line.
4. U.S. Pat. No. 5,443,385, I disclosed a method of disinfecting and lubricating a discrete dental-medical device which comprises immersing the device in a water-alcohol-glycerin-chlorhexidine solution which includes methylcellulose as a lubrication-enhancing and film-forming agent and polyglycol as an antifoaming agent, followed by autoclaving the device.
5. U.S. Pat. No. 5,785,523 I disclosed a system integral with a dental unit. This improved system flushes and disinfects all waterlines of the dental unit.
6. U.S. Pat. No. 6,250,920 I disclosed a system that is detachable to purge a dental unit. This portable system can be taken from one dental unit to another dental unit to flush and disinfect the primary waterline and devices.

Neither of my prior art references discloses this invention's methods comprising to clean and/or lubricate fluid encompassing systems.

### SUMMARY OF THE INVENTION

The present invention provides methods comprising to clean and/or lubricate fluid encompassing systems and said systems' components comprising of fluid conduit(s), and/or fluid reservoir(s), and/or valve(s), and/or device(s). These components for a fluid encompassing system such as a fluid reservoir(s) which may be a mixing tank and/or dental water bottle can also be discrete fluid components that encompass a fluid independently with and/or without a fluid encompassing system. These systems' and components are susceptible to buildup of contamination and remnants from a chemical agent in this system, which can cause equipment failure if not properly maintained by using an effective method comprised to clean and/or lubricate this system.

The present invention are methods comprising to clean and/or lubricate fluid encompassing systems and components comprising of a sequence of procedural steps: purging said system; adding a chemical agent into said system; and resulting with removing comprising a chemical agent and/or contamination from this system by either flushing/rinsing said system, and/or purging said system, and/or both. Some examples of a fluid encompassing system are a soda fountain machine, draft beer keg encompassing system, surgical laser system, beverage brewing machine, and a dental unit water system.

This method ensures a chemical agent's physical and chemical and properties are not altered when applied to this system. This method directs a flow of a chemical agent onto the surfaces of this system's components.

After a fluid encompassing system is cleaned and/or lubricated using this invention's method, this method's final step removes a chemical agent and/or contamination from this system to prevent consumer(s) from ingesting this chemical agent and/or contamination. This method also ensures no residue and no remnants from a chemical agent and/or contamination remains in this system, which helps prevent equipment failure, corrosion, and buildup within said system.

This method helps maintain and/or improve the functionality of this system, which helps prolong the life span of this system and said system's components.

This invention's method also provides a preparatory schedule to be used for fluid encompassing systems that have high CFU counts of contamination in order to prevent clogging of the system's conduit(s) when removing the high counts of contamination from this system.

### DESCRIPTION OF THE PREFERRED EMBODIMENT

The present invention's methods comprising to clean and/or lubricate fluid encompassing systems and said systems' components comprising of fluid conduit(s), and/or fluid reservoir(s), and/or valve(s), and/or device(s). These components for a fluid encompassing system such as a fluid reservoir(s) can also be discrete components that encompass a fluid independently with and/or without a fluid encompassing system.

The term, “discrete” as used herein means a fluid component(s) being disconnected from other systems and handled as a separate unit and/or a fluid component(s) that does not require a system and independently encompasses a fluid. This invention's method discloses how to effectively clean and/or lubricate this discrete fluid component(s) independently encompassing a fluid with and/or without a fluid encompassing system.

The present invention is a method comprising to clean and/or lubricate fluid encompassing systems and components comprising of a sequence of procedural steps: purging said system; adding a chemical agent into said system; and resulting with removing comprising a chemical agent and/or contamination from this system by either flushing/rinsing said system, and/or purging said system, and/or both.

The term “chemical agent” as used herein refers to any chemical composition may be used with this invention's method that helps maintain and/or improve a fluid encompassing system by cleaning and/or lubricating this system and system's components.

Some examples of a fluid encompassing system are a soda fountain machine, draft beer keg encompassing system, surgical laser system, beverage brewing machine, and a dental unit water system.

The invention begins with this method's first step, purging fluid encompassing system, which removes said system's encompassing fluid from this system by a gravity-fed system; and/or purging with a pressurized gas; and/or purging with pressurized gas combined with vacuum suction.

Purging this system is important to be performed as the first procedure of this invention's method. The purpose of this method's first step, purging fluid encompassing system, removes the encompassing fluid from this system and components. This removal of the system's existing fluid ensures that a chemical agent used with this method is not diluted and that a chemical agent directly contacts the surfaces of this system's components, which is the location of the contamination within said system. Diluting a chemical agent will alter the chemical agent's effectiveness and chemical and physical properties.

This method's second step, adds a chemical agent into this fluid encompassing system's empty components, which ensures a chemical agent is not diluted and that a chemical agent directly contacts the surfaces of this system's components. This is important when this method uses a cleaning chemical agent to clean a fluid encompassing system since contamination adheres to the surfaces of this system's components. Furthermore, if this method is using a lubricant as a chemical agent, this invention's method directs the flow of the lubricant to this system's surfaces, which ensures to lubricate the surfaces of this system's components. This method effectively lubricates this system's components such as valves to help maintain and/or improve the functioning of said device(s) and system.

After this period of time of cleaning and/or lubricating this system and components is complete, this method's final step, results with removing comprising of a chemical agent and/or contamination from this system by either flushing/rinsing said system; and/or purging said system; and/or both. Flushing/rinsing said system adds a fluid into said system's fluid system components comprising of fluid conduit(s) and/or fluid reservoir(s). Water may be used as a fluid to flush/rinse system. This method of flushing/rinsing said system could also be achieved by a gravity-fed system. Purging said system is achieved by using a pressurized gas.

The purpose of this method's final step removes a chemical agent and/or contamination from this system to prevent consumer(s) from ingesting this chemical agent and/or contamination. This method's final step also ensures no residue and no remnants from a chemical agent and/or contamination remains in this system, which helps prevent equipment failure, corrosion, and buildup within said system.

Fluid encompassing systems and components will become contaminated if not cleaned properly. This system and components become contaminated regardless if this system's encompassing fluid quality is treated based on the many aforementioned factors that contribute to contamination growth in this system, such as a slow moving fluid in the system, the system's stagnant fluid and from human contamination.

This contaminated fluid encompassing system and system's components will contaminate this system's encompassing fluid when this fluid contacts this system's contaminated components.

When this method uses a cleaning chemical agent routinely to clean this system's contamination, the chemical and physical properties for this system's encompassing fluid are maintained. Furthermore, this method using a cleaning chemical agent also improves this system's fluid flow when dispensed from said system and helps eliminate odor and foul tasting contamination from this system.

This chemical agent remains in the system for a period of time to have an effect upon the contamination. Important to note, this chemical agent will remain in said fluid encompassing system and components when this system is not being utilized comprising of consecutive days until this system is ready to be utilized again.

The same business can have multiple fluid encompassing systems, but each of these systems can have different microbial CFU counts due to the many various factors that contribute to contaminate growth in a system. In regards to ADA (American Dental Association) confirming research that a dental unit system with new dental unit waterlines had high microbial counts as high as 200,000 CFU/mL within 5 days of installing new dental unit waterlines, this invention's method also provides a preparatory schedule to be used for fluid encompassing systems that have high CFU counts of contamination in order to prevent clogging of the system's conduit(s) when removing the high counts of contamination from this system.

This method for said system that has never been cleaned with this method and/or said system contains high microbial CFU counts of contamination comprises a four week preparatory schedule. The purpose of this preparatory schedule avoids this clogging by gradually breaking down the contamination in this system over the course of comprising four weeks while using this invention's method using multiple consecutive treatments of a cleaning chemical agent each week. The first week, this method is consecutively performed every day when said system is utilized during said first week. This method will be performed comprising twice per week comprising weeks from the second week through the fourth week. After the fourth week, this method will be performed on said system routinely comprising once per week.

This invention's method can also be used to clean and/or lubricate pressurized fluid encompassing systems by connecting this system's component(s) to the pressurized gas. A pressurized gas is connected to a chemical agent's pressurized reservoir(s). This pressurized chemical agent reservoir is then connected to the fluid encompassing system's fluid conduit to be clean and/or lubricated. This system's pressurized fluid reservoir will allow a chemical agent to flow into this system when the end valve is opened. A chemical agent remains in this system for a period of time.

After this period of time of cleaning and/or lubricating this system is completed, this method's final step is flushing/rinsing and/or purging said system. The purpose of this final step is to remove comprising said chemical agent and/or contamination from this system, which prevents exposure to consumers of encompassing fluid and/or also prevents the broken down contamination to build up again if it is not removed from this system.

A method comprising to clean and/or lubricate dental unit water system, an example of a fluid encompassing system with said system's encompassing fluid is dental unit water; the fluid conduit(s) are dental unit waterlines; the fluid reservoir(s) are dental water bottle(s) and/or dental water heater(s); valves; and the device(s) are dental handpieces and three-way syringe(s).

This method may also use a lubricant chemical agent that lubricates this dental unit water system's components such as valves, improves said system's operation and efficiency.

The invention's method using a cleaning chemical agent routinely to clean the contamination in this dental unit water system will help maintain and control the dental unit water quality.

It is important to understand the mechanics of each dental unit water system to ensure this system is fully cleaned and/or lubricated before using this invention's method. Understanding the basic mechanics of this dental unit water system will ensure that all of the dental unit water system and components are cleaned and/or lubricated.

A major concern of cleaning the dental unit waterlines is to begin cleaning from the dental unit water source of the dental unit water system. For example, municipal water should begin at this system's junction box and dental unit water bottle systems should begin with the dental water bottle.

Dental unit water systems containing a bottle system that obtains dental unit water from a municipal or well water source should begin cleaning the primary waterline located at this system's junction box. Dental unit water systems that do not clean this primary waterline from the junction box give the misconception that all the dental unit waterlines will be cleaned. The dental unit waterline from the junction box to the bottle system is not cleaned. Therefore, the dental unit is still contaminated. These dental bottle systems can be modified using a remote activated routing valve to correct the problem. Standard dental water bottle systems that switch between municipal and bottled water are not designed to clean the dental unit waterline from the junction box.

Dental unit water systems utilizing dental water bottles that do not have an air purge feature on this system requires an extra step to this invention's method. The dental water bottle must be emptied to perform the air purge portion of this method. It is very important that this dental water bottle and this dental water bottle's pick-up tube to be cleaned before adding the dental unit water to this dental water bottle. This method ensures this dental water bottle and dental water bottle pick-up tube is cleaned before using this method to clean and/or lubricate this dental unit water system.

Furthermore, this invention's method eliminates any dental unit waterline “dead ends” or features that “by pass” parts that have water flow into them. Also, cleaning the dental unit waterlines to the quick disconnect outlet for the cavitron or hydrocolloid system.

In dental units there are open outlets, operable closed outlets and dead ends, an end waterline that is normally kept closed and can only be opened by a system. These outlets must be manually opened to allow the air to force the water out. The dead ends within the dental unit must be opened by a system or the dead end must be removed. Not opening up a water line and preventing the cleaning process increases contamination to the entire dental unit's water and system.

Many dental units are equipped with a water quick disconnect outlet, a dead end. Water quick disconnect, a dental unit waterline, is very often neglected in cleaning and is addressed in this invention's method. It is important that the dental waterline to the quick disconnect is not overlooked as it becomes a harbor for bacteria and will keep the CFU count elevated in the dental unit water.

When a waterline from the block to the handpiece connector will not be used to supply dental unit water to the handpiece, this waterline should be disconnected and the block plugged. Otherwise, this waterline will hold stagnant dental unit water, a source of bacteria, which will contaminate the dental unit water system.

Also, if a dental unit water system has dental water heater, this dental water heater must be turned off before clean and/or lubricating this system. Warm dental unit water temperatures contribute to contamination growth in this system.

This invention's method's first step is to remove all of the dental unit water from the dental unit water system comprising of purging with a pressurized gas; and/or purging with pressurized gas combined with vacuum suction, which purging this system comprises of purging handpiece waterlines; and/or purging dental water heaters; and/or purging the waterline to said dental water system's quick disconnect; and/or purging dental water bottle(s); and/or purging dental unit waterlines.

Compressed air is an example of pressurized gas to purge this dental unit water system. Deliver clean compressed air into the dental unit's initial waterline site. This initial site may be a waterline coming from a municipal source or from a dental water bottle. This compressed air must be distributed from this initial site through the complete dental unit's water system: dental water bottle(s), dental unit waterlines and valves. The dental water bottle is empty and is attached to the dental unit. Purge dental waterlines by activating this system's devices: handpiece hoses and three-way syringes until dental unit water is eliminated.

Purging system is a critical step to this invention's method. Purging this system removes the dental unit water from system before adding a chemical agent. Adding a chemical agent into an empty dental unit water system ensures a chemical agent is not diluted and also that this chemical agent comes into direct contact the surfaces of this system's components: dental unit waterlines, dental water bottles and valves. This method's first step, purging system, ensures a chemical agent's physical and chemical and properties are not altered when a chemical agent is applied to this system.

This method's second step adds a chemical agent into said empty dental unit water system components comprising of dental unit waterlines; and/or dental water bottle(s); and/or valves.

When adding a chemical agent to an empty dental water bottle, it is important that this bottle is clean prior to adding chemical agent. The contamination in the dental water bottle can affect the efficacy of the chemical agent.

In the beginning of this method's second step addresses cleaning the dental water bottle and this dental water bottle's pick-up tube with a cleaning chemical agent, which are the beginning sources of contamination growth in the dental water system.

In order to clean a dental water bottle, this cleaning chemical agent is added into an empty dental water bottle(s) while placing a bottle closure or using a clean cloth over said dental water bottle's opening. Rotate said dental water bottle(s) upside down to an inverted position comprising one time to coat the internal surfaces of this contaminated dental water bottle with a cleaning chemical agent while said cloth and/or bottle closure is covering over said dental water bottle opening. A cloth that is saturated with a cleaning chemical agent is used to wipe down the exterior surface of the contaminated dental water bottle's pick-up tube and internal surface of the dental unit's manifold. Coating this dental water bottle and pick-up tube with a cleaning chemical agent will breakdown the contamination that adheres to these surfaces.

Allow a cleaning chemical agent to remain in said dental water bottle while attached to dental unit comprising a period of time to clean the bottle based on the manufacturer of the cleaning chemical agent recommendation. If an additional dental unit water bottle is being cleaned simultaneously as the other dental water bottle is being cleaned while attached to the dental unit, then seal this additional dental water bottle with a clean bottle closure.

Now that this dental water bottle is clean, add a chemical agent to this empty clean dental water bottle. Attach this clean dental water bottle containing a chemical agent to the dental unit manifold. When the dental water bottle with this chemical agent becomes pressurized and the ends of the dental waterline are opened, this chemical agent will be conveyed from this dental water bottle into this system's valves and dental water lines. The handpiece hoses and three-way syringes are activated causing this chemical agent to exit the dental unit's waterlines end, the valves controlling the flow of said chemical agent through the dental unit's water system is stopped and/or the pressure to the dental water bottle is stopped. The staff member will recognize that this chemical agent exiting this system's devices confirms that dental unit waterlines are filled with this chemical agent since the first step purged the system, removing all fluids from system before adding this chemical agent to this system.

After the lubricating and/or cleaning period is completed, dispose remaining said chemical agent and rinse dental water bottle with water after said chemical agent has cleaned and/or lubricated said system and components comprising of dental water bottle, dental waterlines, and valves.

This method's second step, directs a chemical agent to target the system's surfaces. Contamination is attached to these system's surfaces, and this method will direct a cleaning chemical agent to this system's contamination. This method's second step also ensures a lubricant chemical agent contacts this system's components such as lubricating this system's valves.

This invention's method's final step of flushing/rinsing; and/or purging said dental unit water system; and/or both is necessary to clean and/or lubricate said system by removing comprising a chemical agent and/or contamination from this dental unit water system.

This method's final step adds a fluid into said dental unit water system to flush/rinse and/or purge components comprising of dental waterlines and/or said empty clean dental water bottle(s) for flushing/rinsing and/or purging said dental unit water system for a designated period of time.

This method's flushing/rinsing step adds a fluid into said system's dental unit waterlines and/or dental water bottle. Water may be used as a fluid for flushing/rinsing said dental unit water system. The dental water bottle is filled with a water source and this dental water bottle is attached to the dental unit. Filling the dental water bottle with water and opening the controlling valves of the dental waterlines will cause pressurized dental unit water from this dental water bottle to go through the dental unit waterlines expelling said chemical agent. If a cleaning chemical agent was used as the chemical agent with this method, then contamination will also be expelled in this step. This method of flushing/rinsing said dental unit water system could be also achieved by a gravity-fed system

This method's final step can also be achieved by purging dental unit water system by using a pressurized gas as fluid. The dental water bottle is empty and attached to the dental unit. Compressed air is an example of a pressurized gas used to purge this system, whereas this compressed air pressurizes the empty dental water bottle and opens the controlling valves of the dental waterlines, which causes the pressurized air to go through the dental waterlines expelling said chemical agent. If a cleaning chemical agent was used as the chemical agent with this method, then contamination will also be expelled in this method's step. This dental unit water system is now clean and/or lubricated. Fill this system with preferred dental unit water and begin dental procedures.

This invention's method is compatible with all dental units and is performed while patients are not present in the dental operatory. This method′ final step of removing comprising a chemical agent and/or contamination from said system before dental unit water system is utilized for dental procedures ensures that a chemical agent and/or contamination does not impact the dental unit water quality and patients are not consuming the chemical agent and/or contamination.

Contamination will still grow in this dental unit water system regardless of the dental unit water source and water treatment products used in the dental office. Establishing standards for dental unit water quality is part of the equation; however, even if a dental office takes precautions to treat their dental unit water source, this step does not address the contamination in the dental unit water system and components: dental unit waterlines, valves and dental water bottles. This system and components become contaminated regardless if the dental unit water is treated based on the many aforementioned factors that contribute to contamination growth in this system, such as a slow moving dental unit water, the system's stagnant dental unit water and from human contamination.

Dental offices should implement this invention's method using a cleaning chemical agent into their infection control protocol routinely in order to clean the contamination in this dental unit water system to ensure quality dental unit water is provided to patients that consistently meets the recommended CDC water standards. This method using a lubricant as chemical agent will lubricate this dental unit water system, which improves this system's operation and efficiency.

Industries that use a fluid encompassing system must also use a cleaning regimen such as this invention's method in order to address the contamination in this system and components. This invention's method using a cleaning chemical agent wherein a fluid component is a fluid reservoir(s) is a discrete fluid reservoir independently encompassing a fluid with and/or without a fluid encompassing system comprising this method of using said cleaning chemical agent to clean said discrete fluid reservoir. Add said cleaning chemical agent into this empty discrete fluid reservoir while placing said fluid reservoir's closure on said fluid reservoir's opening or place a clean cloth over said fluid reservoir's opening. Rotate said fluid reservoir upside down to an inverted position comprising one time to coat the inner walls of this fluid reservoir with said cleaning chemical agent while said cloth or said fluid reservoir's closure is covering said fluid reservoir's opening. Allow said cleaning chemical agent to remain in said fluid reservoir while sealed with a clean container closure for a period of time. When this period of time is fulfilled, dispose remaining said cleaning chemical agent and rinse said fluid reservoir with water after said cleaning chemical agent has cleaned said fluid reservoir.

This invention's method is also applied to cleaning and/or lubricating a draft beer keg dispensing system, another common example of a fluid encompassing system.

This method wherein the draft beer keg dispensing system's encompassing fluid is draft beer; wherein said beer system's components comprising the fluid conduit(s) are keg beer line(s) and/or pressurized gas line(s); the fluid reservoir(s) are beer keg(s), and/or pressurized said chemical agent container(s), and/or pressurized gas cylinder(s); the valve(s) are a keg coupler(s) and/or pressure regulator(s); and the device(s) are a encompassing beer faucet(s) and/or encompassing beer faucet handle(s). Draft beer, the encompassing fluid for a draft beer keg encompassing system, flows through a keg line, a fluid conduit, from the keg beer, a fluid reservoir, to the encompassing beer faucet, a device.

The contamination in this beer system is a build up of contamination on the surfaces of this system's components. If the contamination remains in said beer system, these contaminates will alter the beer's taste, unless this invention's method of using a cleaning chemical agent is performed routinely to clean this beer keg system, which will provide the consumer a consistent quality of beer that is not bacterially penetrated and contaminated.

This invention's method performed routinely with a cleaning chemical agent cleans the contamination in this draft beer keg dispensing system, which also helps maintain and control the chemical and physical properties for this system's draft beer, which is this system's encompassing fluid. This method using a lubricant as a chemical agent lubricates this draft beer keg dispensing system such as the ball bearing mechanism in a beer faucet, which improves this system's overall operation and efficiency.

This method's first step is to purge said beer system by removing all of the existing beer from beer faucet and keg line. This first step comprises of purging said beer faucet(s); and/or purging said keg line(s) that is unattached from beer keg(s) by using a clean and/or lubricate coupler(s) that is attached to a pressurized gas cylinder(s).

This method's second step adds a chemical agent by using a clean coupler(s) from the said pressurized chemical agent container(s) into empty keg line(s). This second step comprises of filling keg line(s) with a chemical agent; and/or immerses valve(s) comprising contaminated keg beer coupler(s) and/or beer faucet handle ball bearing mechanism(s) with said chemical agent. Saturate clean cloth with said chemical agent and wipe down the external beer faucet(s) opening. After said chemical agent has clean and/or lubricated said valve(s), dispose remaining said chemical agent and rinse said valve(s) with water.

This method's final step results with removing comprising said chemical agent and/or contamination from this beer system by either flushing/rinsing said system; and/or purging said system; and/or both.

This method's final step adds a fluid into said beer system's components comprising of keg line(s) for flushing/rinsing and/or purging said beer system. This method's final step may use water as a fluid for flushing/rinsing said beer system; and/or a gravity-fed system. Pressurized gas may be the fluid used to purge this system.

The purpose of this method's final step of removing comprising this chemical agent and/or contamination from this system, helps maintain the draft beer's taste, chemical and physical properties. This method's final step also ensures that this chemical agent and/or contamination does not remain in this system for possible consumption and buildup of remnants and contaminates.

When this invention's method comprising to clean and/or lubricate all fluid encompassing systems is completed, a regimen should implement this method on a routine basis in order to properly maintain these systems. Industries that use a fluid encompassing system must be clean because they are susceptible to contamination growth.

This invention's method comprises to clean and/or lubricate all fluid encompassing systems that dispenses a fluid or fluids for in vitro and/or in vivo procedures and/or for consumption. This invention's method using a cleaning chemical agent performed routinely cleans the contamination in these systems, which ensures this system's end product, the encompassing fluid, is not contaminated. Lubricating this system routinely with this invention's method using a lubricant helps prolong the life span of this system and components.

This invention's methods comprised to clean and/or lubricate fluid encompassing systems and systems' components comprising of a sequence of procedural steps. These systems' and components are susceptible to buildup of contamination and remnants from a chemical agent in this system, which can cause equipment failure if not properly maintained by using an effective method comprised to clean and/or lubricate this system.

This method ensures a chemical agent's physical and chemical and properties are not altered when applied to this system. This method directs a flow of a chemical agent onto the surfaces of this system's components.

After this system is cleaned and/or lubricated using this invention's method, this method's final step removes a chemical agent and/or contamination from this system to prevent consumer(s) from ingesting this chemical agent and/or contamination. This method also ensures no residue and no remnants from a chemical agent and/or contamination remains in this system, which helps prevent equipment failure, corrosion, and buildup within said system.

This method helps maintain and/or improve the functionality of this system, which helps prolong the life span of this system and said system's components.

We claim:

1. Methods comprising to clean and/or lubricate fluid encompassing systems and said systems' components comprising of fluid conduit(s), and/or fluid reservoir(s), and/or valve(s), and/or device(s), which comprises
a) a method comprised to clean and/or lubricate a fluid encompassing system and this system's components comprising of a sequence of procedural steps: purging said system, adding a chemical agent into said system, and resulting with removing comprising a chemical agent and/or contamination from this system by either flushing/rinsing said system; and/or purging said system; and/or both.

2. A method according to claim 1 wherein this method uses any chemical agent that helps maintain and/or improve the functionality of this system comprising of
a) a cleaning chemical agent that cleans the contamination in this system; and/or
b) a lubricant chemical agent that is used for lubricating system and system's components.

3. A method according to claim 1 wherein this method directs a flow of a chemical agent onto the surfaces of this system's components.

4. A method according to claim 1 wherein this method ensures that no residue and no remnants from a chemical agent and/or contamination remain in this system, which helps prevent equipment failure, corrosion, and buildup within said system.

5. A method according to claim 1 wherein this method ensures that a chemical agent is not diluted, in order to prevent altering the efficacy of the chemical agent and the chemical agent's chemical and physical properties.

6. A method according to claim 1 wherein a method using a cleaning chemical agent to help clean and control the contamination in this system, comprises of
a) this method is performed routinely to clean the contamination in this system, which helps maintain the chemical and physical properties for this system's encompassing fluid;
b) this method improves said system's operation and efficiency by prolonging the life span of said system and this system's components which comprises by
i. cleaning said system by directing a cleaning chemical agent upon the contaminated surfaces of said system and said system's fluid system components;
ii. eliminating odor and foul tasting contamination from said system;
iii. improving the flow of said system's encompassing fluid; and
c) this method's final step results with removing comprising a chemical agent and contamination from said system comprising of
i. after system is cleaned using this method, this method's final step removing a chemical agent and contamination from this system prevents consumer(s) from ingesting this chemical agent and contamination; and
ii. this method's final step of removing a chemical agent and contamination from this system ensures no residue and no remnants from a chemical agent and/or contamination remain in this system, which helps prevent equipment failure, corrosion, and buildup within said system.

7. A method according to claim 1 wherein this method's first step is to purge said system by completely removing this system's encompassing fluid, comprising
a) this method of purging said system removes said system's encompassing fluid by a gravity-fed system; and/or
b) this method of purging said system removes said system's encompassing fluid by using a pressurized gas; and/or
c) this method of purging with pressurized gas combined with vacuum suction.

8. A method according to claim 1 wherein this method's second step adds a chemical agent into said system.
a) A chemical agent is added to this system's empty fluid system components comprising of fluid reservoir(s), and/or fluid conduit(s), valve(s), and/or device(s).

9. A method according to claim 1 wherein this method's final step results with removing comprising a chemical agent from this system by either flushing/rinsing said system; and/or purging said system; and/or both in a preferred order; comprising
a) this method adds a fluid into said system's fluid system components comprising of fluid conduit(s) and/or fluid reservoir(s) for flushing/rinsing said system; and/or
i. this method's final step may use water as a fluid for flushing/rinsing said system; and/or
b) this method of flushing/rinsing said system is achieved by a gravity-fed system; and/or
c) this method of purging said system is achieved by using a pressurized gas; and
d) this method's final step helps prevent altering the taste, chemical and physical properties of said system's end dispensing fluid, and does not result in consumer exposure to comprising said chemical agent and/or contamination.

10. A method according to claim 1 wherein this method using a disinfectant/cleaning product as a chemical agent to clean and control the contamination for this system that has never been disinfected with this method and/or said system contains high CFU counts of contamination comprising a four week preparatory schedule which comprises
a) the first week, this method is consecutively performed every day when said system is utilized during said first week;
b) this method will be performed comprising twice per week comprising weeks from the second week through the fourth week;
c) after the fourth week, this method will be performed on said system routinely comprising once per week; and
d) when this system is not being utilized comprising of consecutive days, then this method's second step of adding a chemical agent will remain inside this system. This method's final step will be completed once this system is ready to be utilized again.

11. A method according to claim 1 wherein this fluid encompassing system is not being utilized comprising of consecutive days, then this method's second step of adding a chemical agent will remain inside this system. This method's final step will be completed once this system is ready to be utilized again.

12. A method according to claim 1 wherein a fluid encompassing system is a pressurized fluid encompassing/dispensing system which comprises
a) this method comprises to clean and/or lubricate said system resulting with this method's final step, which prevents altering the taste, chemical and physical properties of said system's end dispensing fluid, and does not result in consumer exposure to comprising said chemical agent and/or contamination when this method comprises the following steps:
b) this method's first step is to purge said system by removing all of the existing fluid from said system's components comprising of
i. purging said valve(s); and/or
ii. purging said fluid conduit(s) that is unattached from said system's fluid system by using a clean valve(s) that is attached to a pressurized gas cylinder(s); and/or
iii. this method of purging with pressurized gas combined with vacuum suction.
c) this method's second step adds a chemical agent by using a clean valve(s) from a pressurized chemical agent container(s) into empty fluid conduit(s) and/or empty fluid reservoir(s) comprising
i. fill fluid conduit(s) and/or fluid reservoir(s) with a chemical agent; and/or
ii. immerse valve(s) with a chemical agent; and/or
iii. saturate clean cloth with chemical agent and wipe down said system's external fluid dispenser; and/or
iv. after said chemical agent has cleaned and/or lubricated said system, dispose remaining said chemical agent and rinse said valve(s), and/or fluid conduit(s) and/or fluid reservoir(s) with water.
d) a method according to claim 1 wherein this method's final step is flushing/rinsing and/or purging said system to remove comprising chemical agent and/or contaminates from this system comprising
i. this method adds a fluid into said system's components comprising of fluid conduit(s) and/or said fluid reservoir(s) for flushing/rinsing said system; and/or
ii. this method's final step may use pressurized water as a fluid for flushing/rinsing said system; and/or
iii. this method of flushing/rinsing said system is achieved by a gravity-fed system; and/or
iv. this method of purging said system is achieved by using a pressurized gas.

13. A method according to claim 1 wherein a fluid encompassing system is a dental unit water system; said system's encompassing fluid is dental unit water; the fluid conduit(s) are dental unit waterlines; the fluid reservoir(s) are dental water bottle(s) and/or dental water heater(s); the valves; and the device(s) are dental handpieces and three-way syringe(s) which comprises
a) this method comprises to clean and/or lubricate said dental system is compatible with all dental units comprises the following steps:
b) this method's first step is to remove all of the dental unit water from the dental unit water system comprising of purging with a pressurized gas and/or purging with pressurized gas combined with vacuum suction, which purging this system comprises of
i. purging handpiece waterlines; and/or
ii. purging dental water heaters; and/or
iii. purging valves; and/or
iv. purging the waterline to said dental water system's quick disconnect; and/or
v. purging dental water bottle(s); and/or
vi. purging dental unit waterlines;
c) this method's second step adds a chemical agent into said dental unit water system components comprising dental unit waterlines; and/or dental water bottle(s); and/or valves comprising
i. add chemical agent into empty dental water bottle(s) while placing a bottle closure or use a clean cloth over said dental water bottle's opening. Rotate said dental water bottle(s) upside down to an inverted position comprising one time to coat the internal surfaces of this contaminated dental water bottle with chemical agent while said cloth and/or bottle closure is covering over said dental water bottle opening; and/or
ii. a cloth that is saturated with a chemical agent is used to wipe down the exterior surface of the contaminated dental water bottle's pick-up tube and internal surface of the dental unit's manifold; and/or
iii. allow chemical agent to remain in said dental water bottle for a period of time while attached to dental unit or sealed with a clean bottle closure; and/or
iv. dispose remaining chemical agent and rinse dental water bottle with water after chemical agent has cleaned and/or lubricated said dental water bottle; and/or
d) A method according to claim 1 wherein this method's final step is flushing/rinsing and/or purging said dental unit water system to remove comprising chemical agent and/or contamination from this dental unit water system comprising
i. this method adds a fluid into said dental unit water system's components comprising of dental waterlines and/or said empty clean dental water bottle(s) for flushing/rinsing said dental unit water system; and/or
ii. this method's final step may use water as a fluid for flushing/rinsing said dental unit water system; and/or
iii. this method of flushing/rinsing said dental unit water system is achieved by a gravity-fed system; and/or
iv. this method of purging said dental unit water system is achieved by using a pressurized gas.
e) This method using a cleaning chemical agent comprises to clean and control the dental unit water quality by cleaning the contamination of said dental water system, improves the efficiency and operation of this system, resulting with a flush/rinse and/or purging of said system that does not impact dental operative procedures and does not result in patient exposure to this cleaning chemical agent and/or contamination when using this method.

14. A method according to claim 1 wherein said components comprising conduit(s), and/or reservoir(s), and/or valve(s), and/or device(s) are discrete components that encompass a fluid and function independently with and/or without a fluid encompassing system are cleaned and/or lubricated using this method comprising
a) add chemical agent into an empty discrete component such as an empty discrete reservoir while placing said reservoir's closure on said reservoir's opening or place a clean cloth over said reservoir's opening. Rotate said reservoir upside down to an inverted position comprising one time to coat the inner walls of this reservoir with chemical agent while said cloth or said reservoir's closure is covering said reservoir's opening; and/or
b) allow said chemical agent to remain in said reservoir while sealed with a clean container closure; and/or
c) dispose remaining chemical agent and rinse said reservoir with water after chemical agent has cleaned and/or lubricated said reservoir; and
d) a discrete component(s) independently encompassing a fluid with and/or without a fluid encompassing system wherein is a dental water bottle(s); thermos bottle(s); water jug(s); dispensing cooler(s); beverage container(s); canteen(s); cask(s); non-dishwasher safe reservoir(s); flask(s); reservoir(s) with long reservoir necks; mixing tank(s); vat(s); kettle(s); teapot(s); pot still(s); a distillation apparatus; and other fluid encompassing discrete components.

15. A method according to claim 1 wherein a fluid encompassing system is a draft beer keg dispensing system; the system's encompassing fluid is draft beer; wherein said beer system's components comprising the fluid conduit(s) are keg beer line(s) and/or pressurized gas line(s); the fluid reservoir(s) are beer keg(s), and/or pressurized chemical agent container(s), and/or pressurized gas cylinder(s); the valve(s) are a keg coupler(s) and/or pressure regulator(s); and the device(s) are a dispensing beer faucet(s) and/or dispensing beer faucet handle(s) which comprises
a) this method using chemical agent comprises to clean and/or lubricate said beer system and is compatible with all draft beer keg dispensing systems resulting with this method's flush/rinse and/or purging said system that does not impact the taste, chemical and physical properties of said system's end dispensing fluid, draft beer, and does not result in consumer consumption of chemical agent and/or contamination when performing this method comprising the following steps:
b) this method's first step is to purge said system by removing all of the existing beer from beer faucet and keg line comprising of
i. purging said beer faucet(s); and/or
ii. purging said keg line(s) that is unattached from beer keg(s) by using a clean coupler(s) that is attached to a pressurized gas cylinder(s).
c) this method's second step adds a chemical agent by using a clean coupler(s) from a pressurized chemical agent container(s) into empty keg line(s) comprising
i. fill keg line(s) with a chemical agent; and/or
ii. immerse valve(s) comprising contaminated keg beer coupler(s) and/or beer faucet handle ball bearing mechanism(s) with a chemical agent; and/or
iii. saturate clean cloth with a chemical agent and wipe down the external beer faucet(s) opening; and/or
iv. after a chemical agent has cleaned and/or lubricated said valve(s), dispose remaining chemical agent and rinse said valve(s) with water; and/or
d) A method according to claim 1 wherein this method's final step is flushing/rinsing and/or purging said beer system to remove chemical agent and/or contamination from this beer system comprising
i. this method adds a fluid into said beer system's components comprising of keg line(s) for flushing/rinsing said beer system; and/or
ii. this method's final step may use water as a fluid for flushing/rinsing said beer system; and/or
iii. this method of flushing/rinsing said beer system is achieved by a gravity-fed system; and/or
iv. this method of purging said beer system is achieved by using a pressurized gas.

16. A method according to claim 1 wherein this method comprises to clean and/or lubricate all fluid encompassing systems and/or components wherein a fluid encompassing system is a distillation apparatus; distiller(s); pot still(s); surgical laser system(s); blood transfusion machine(s); medical/dental systems that encompass fluid(s); dairy milking operation system(s); pressurized fluid encompassing system(s); dental unit water system(s); catheter(s); beverage brewing system(s); coffee maker(s); machine(s) for beverages such as tea, hot chocolate, apple cider and/or coffee; kettle(s); teapot(s); draft beer keg system with encompassing beer faucet(s); soda fountain encompassing machine(s); kidney dialysis machine(s); sleep apnea machine(s); ice cream/frozen yogurt encompassing machine(s); beverage container(s) with dispenser; water cooler machine(s); wine encompassing machine(s); frozen beverage encompassing machine(s); and other fluid encompassing systems(s).
